(19) United States
(12) Patent Application Publication
(10) Pub. No.: US 2010/0216005 A1
(43) Pub. Date: Aug. 26, 2010

(54) BATTERY COVER LATCHING ASSEMBLY

(75) Inventor: XIAN-JUN ZENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/578,977

(22) Filed: Oct. 14, 2009

(30) Foreign Application Priority Data
Feb. 26, 2009 (CN) 200910300572.0

(51) Int. Cl. H01M 2/10

(52) U.S. Cl. 429/100

(57) ABSTRACT

A battery cover latching assembly comprises a battery housing member, a battery cove and a button. The battery cover is releasably mounted to the battery housing member. The button is slidably mounted to the battery cover and has a grip portion forming thereon. When the button is slid away from the battery cover, the grip portion is exposed from the battery housing member to facilitate detaching the battery cover from the battery housing member.

### BACKGROUND

1. Technical Field

The exemplary disclosure generally relates to battery cover latching assemblies, particularly to a battery cover latching assemblies used in portable electronic devices.

2. Description of Related Art

As a power source, batteries are widely used in portable electronic devices, such as personal digital assistants (PDAs), cellular phones and etc. Conventional batteries are received in the electronic devices, and battery covers are designed to attach with housings of the electronic devices to package the batteries. The batteries have to be replaced by opening the battery covers when the batteries are damaged or can not be recharged with electricity any more.

A clasp structure or latch structure is used with a conventional battery cover to engage with a housing of a portable electronic device. For example, a latch comprises a pair of hooks at one end of the battery cover and a locking pin protruding from the other end of the battery cover. Accordingly, a pair of troughs is defined in an end portion of a backside of a housing of the cellular phone, and a locking hole is defined in the other end portion of the backside of the housing. In assembly, the hooks are firstly inserted into the troughs in the backside of the housing. Then, the battery cover is pressed downwardly to the housing until the locking pin on the battery cover is inserted into the locking hole in the backside of the housing. The battery cover is thus assembled to the housing of the cellular phone. However, during disassembly, the battery cover is susceptible to being damaged, since a greater force is exerted thereon. As a result, it is inconvenient for a user to change a battery in the housing of the portable electronic device.

Therefore, there is a room for improved in the arts.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary battery cover latching assembly. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary embodiment of a battery cover latching assembly including a battery housing member, a battery cover and a button.

FIG. 2 is an enlarged view of the button showing in FIG. 1.

FIG. 3 is similar to FIG. 1, but showing the battery cover latching assembly in another aspect.

FIG. 4 is a schematic view of the button latching with the batter cover.

FIG. 5 is an assembled view of the battery cover latching assembly shown in FIG. 3.

FIG. 6 is a partially enlarged and cross-sectional view of the battery cover latching assembly showing in FIG. 5 along the line of VI-VI.

FIG. 7 is a cross-sectional view of the battery cover latching assembly showing in FIG. 5 along the line of VII-VII.

FIG. 8 is a partially enlarged view of the battery cover latching assembly showing in FIG. 5.

FIG. 9 is a cross-sectional view of the battery cover latching assembly showing in FIG. 8 along the line of IX-IX.

### DETAILED DESCRIPTION OF THE EMBODIMENTS

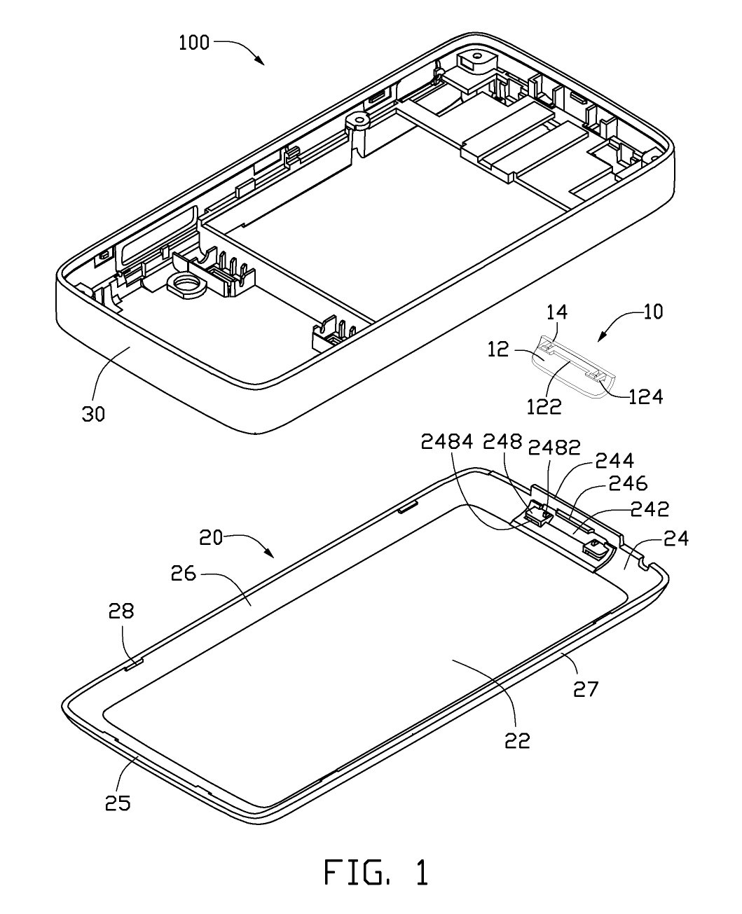

Referring to FIG. 1, an exemplary battery cover latching assembly 100 used in a portable electronic device for accommodating a battery is shown. The battery cover latching assembly 100 includes a button 10, a battery cover 20 and a battery housing member 30. The battery cover 20 is to be latched to the battery housing member 30. The button 10 is mounted to the battery cover 20, to facilitate detaching the battery cover 20 from the battery housing member 30.

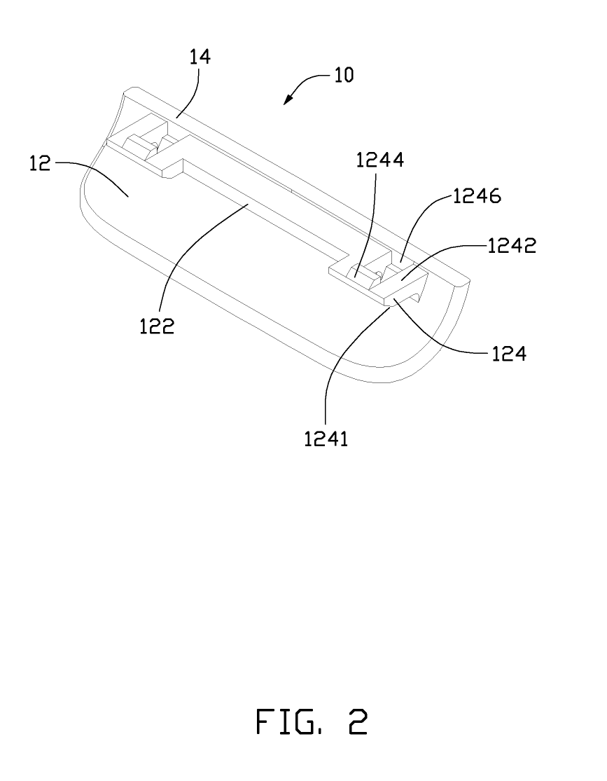

Referring to FIG. 2, the button 10 is substantially curved and includes an inner surface 12 facing the battery cover 20 and a side surface 14 connecting with the inner surface 12. The button 10 has a resisting portion 122 protruding from the inner surface 12 along the side surface 14. The button 10 further has two sliding members 124 protruding from the inner surface 12 and respectively located at opposite ends of the resisting portion 122. Each sliding member 124 has a wedged surface 1241 formed at a distal end thereof, such that the sliding members 124 can be easily mounted to the battery cover 20. Each sliding member 124 further includes a second surface 1242. A stopping portion 1244, such as a block protruding from the second surface 1242 opposite to the wedged surface 1241. The stopping portion 1244 is configured to stop the sliding members 124 sliding away from the battery cover 20. Moreover, each sliding member 124 has a slot 1246 defined in the second surface 1242. The slot 1246 is latched with the battery cover 20 to attach the button 10 to the battery cover 20.

The battery cover 20 includes a bottom wall 22 and a plurality of sidewalls extending from the bottom wall 22. The sidewalls includes a first sidewall 24, a second sidewall 25 opposite to the first sidewall 24, a third sidewall 26 and a fourth sidewall 27 opposite to the third sidewall 26. The third sidewall 26 and the fourth sidewall 27 respectively connect the first sidewall 24 to the second sidewall 25.

The battery cover 20 has an opening 242 defined through the first sidewall 24 and a positioning portion 244 protruding from a distal end of the first sidewall 24. The sliding members 124 and the resisting portion 122 enter into the battery cover 20 via the opening 242. The positioning portion 244 is configured to precisely mount the battery cover 20 to the battery housing member 30. The battery cover 20 further includes a securing portion 246 protruding from an inner surface of the first sidewall 24 and two L-shaped platforms 248 protruding from an inner surface of the bottom wall 22. The securing portion 246 is a flat plate protruding along the positioning portion 244 and located adjacent to one side of the opening 242. The securing portion 246 is configured to resist against the resisting portion 122 of the button 10. The platforms 248 are located adjacent to another side of the opening 242 corresponding to the sliding member 124 of the button 10. Each platform 248 has a projection 2482 protruding upwardly and configured for releasably latching with the slot 1246 of the button 10. The battery cover 20 further has two gaps 2484 formed between the platforms 248 and the bottom wall 22, such that the platforms 248 can be deflected toward the bottom wall 22 when the platforms 248 are pressed.

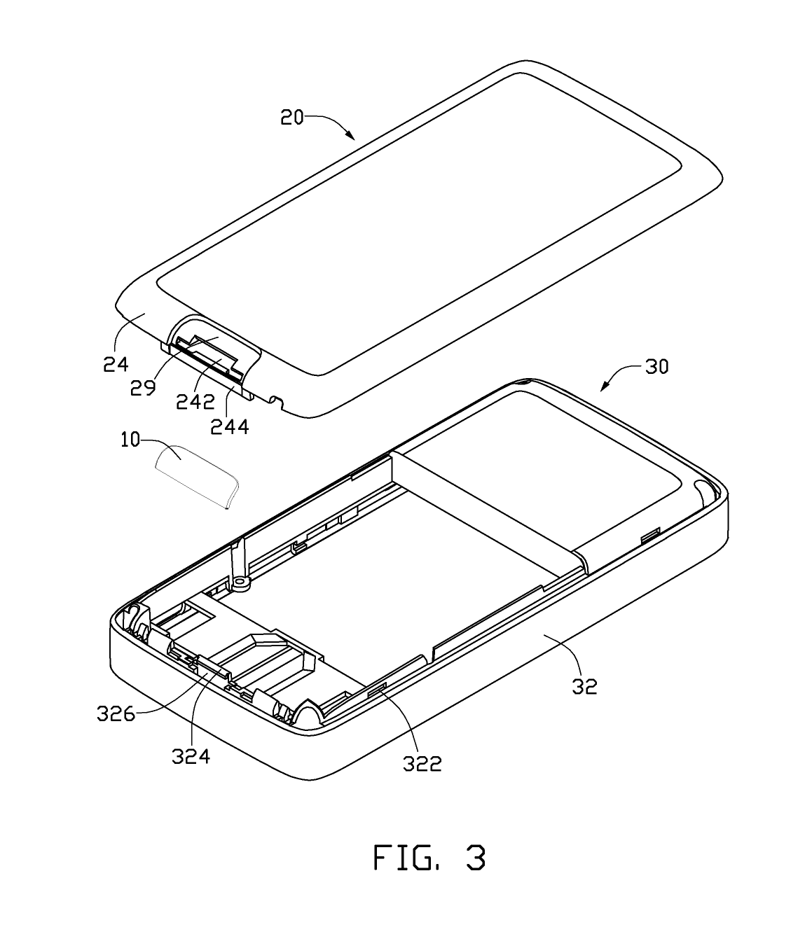

The battery cover 20 further has a receiving groove 29 (FIG. 3) defined in an outer surface of the first sidewall 24. The receiving groove 29 accommodates the button 10. Moreover, the battery cover 20 has a plurality of latching portions 28 (FIG. 1) respectively protruding from the second sidewall 25, the third sidewall 26 and the fourth sidewall 27. The latching portions 28 are configured to latch with the battery housing member 30.

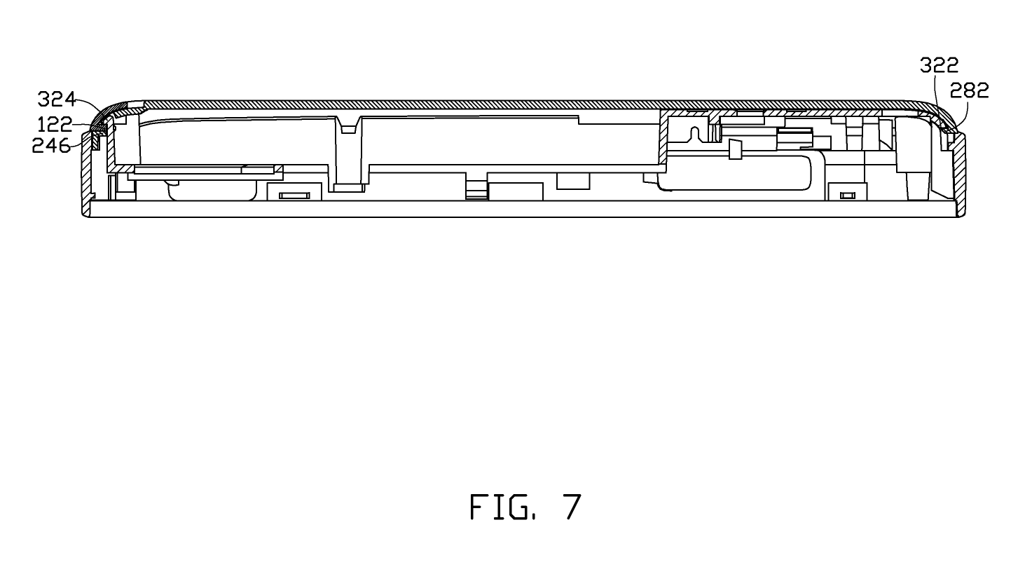

Referring to FIG. 3, the battery housing member 30 includes a peripheral wall 32. The battery housing member 30 has a plurality of latching recesses 322 defined in the peripheral wall 32 corresponding to the latching portions 28 of the battery cover 20. The latching recesses 322 are configured to latch with the latching portions 28. Referring to FIG. 7, the battery housing member 30 further has a hook 324 protruding from an inner surface of the peripheral wall 32 and latching with the securing portion 246 of the battery cover 20. The battery housing member 30 has positioning hole 326 defined between the hook 324 and the peripheral wall 32 corresponding to the positioning portion 244 of the battery cover 20.

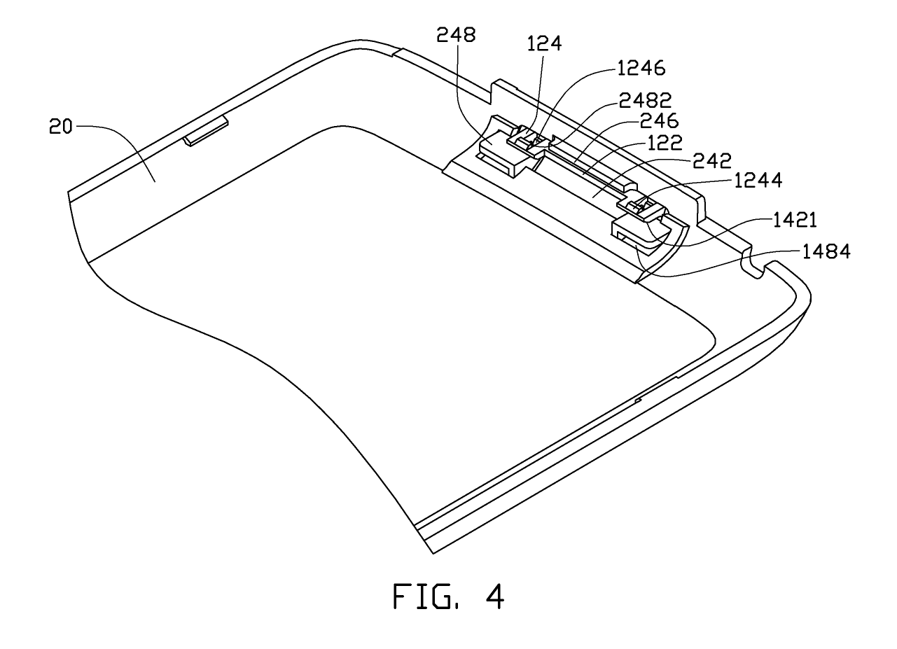

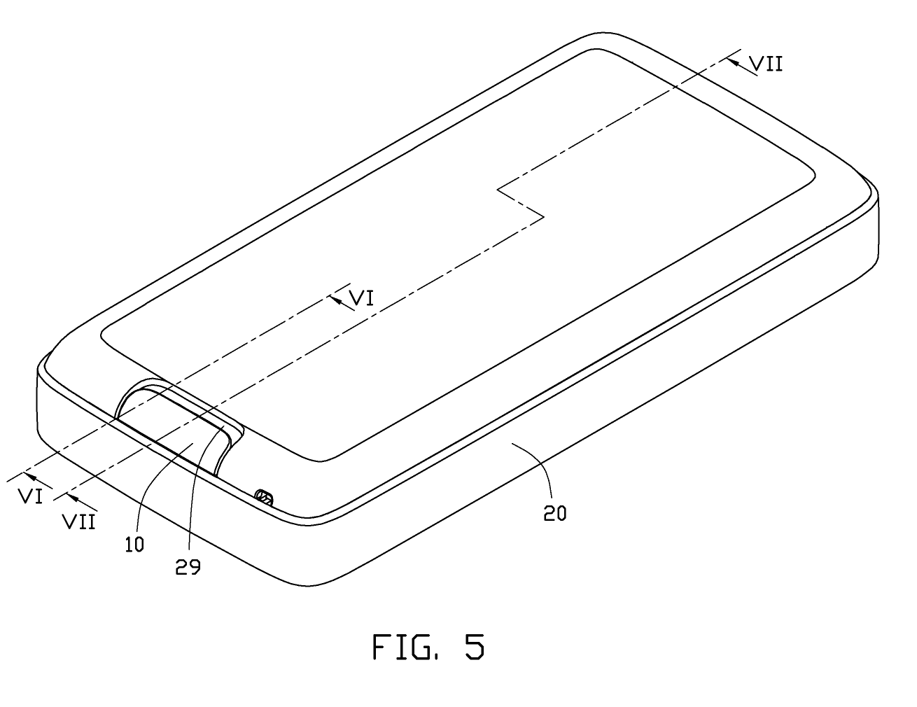

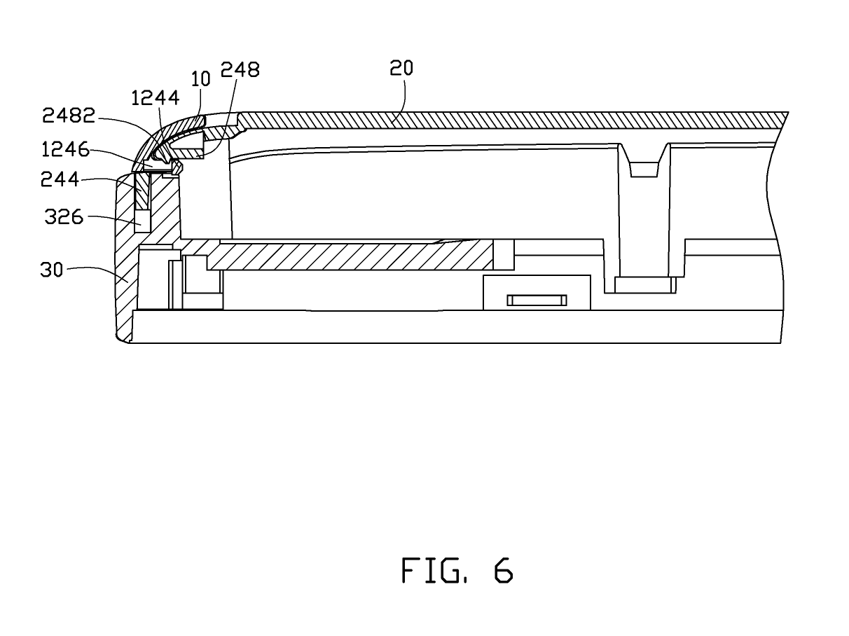

Referring to FIGS. 4 to 6, when assembling the battery cover latching assembly 100, firstly, the sliding members 124 are pressed into the battery cover 20 through the opening 242, with the sliding members 124 biasing the platforms 248 toward the bottom wall 22, until the projections 2482 on the platforms 248 are aligned with and latched into the slots 1246 of the sliding members 124. At this time, the sliding members 124 are resisted against the platform 248, and the resisting portion 122 is resisted against the securing portion 246 of the battery cover 20 such that the button 10 is firmly held between the platforms 248 and the securing portion 246. Then, the latching portions 28 of the battery cover 20 are aligned with the latching recesses 322 of the battery housing member 30, the positioning portion 244 of the battery cover 20 is aligned with the positioning hole 326 of the battery housing member 30. The battery cover 20 is pressed toward the battery housing member 30, until the latching portions 28 are latched in the latching recesses 322 and the positioning portion 244 is accommodated in the positioning hole 326. At this time, referring to FIG. 7, the resisting portion 122 is latched with the hook 324 of the battery housing member 30, thus yielding to an assembled battery cover latching assembly 100.

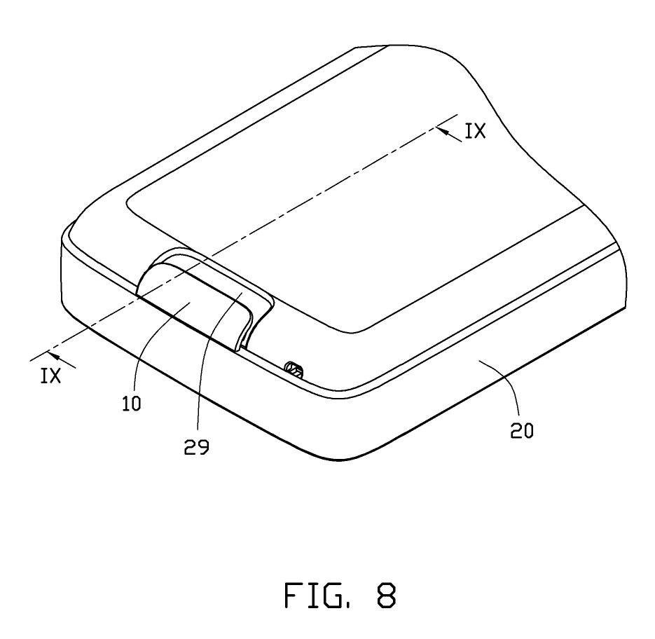

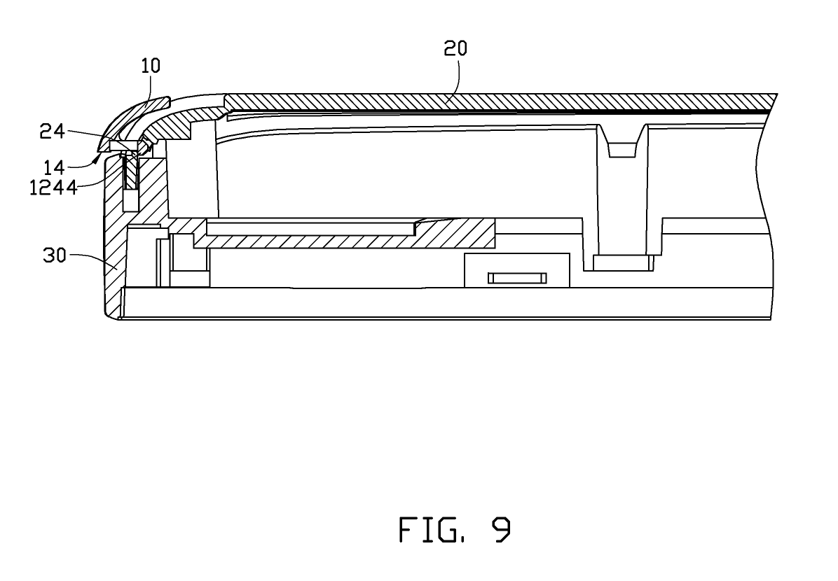

Referring to FIGS. 8 and 9, when detaching the battery cover 20 from the battery housing member 30, the button 10 is slid away from the battery cover 20 such that the projections 2482 of the platforms 248 are slid out of the slot 1246 of the sliding members 124, until the stopping portions 1244 of the button 10 are resisted against the first sidewall 24 of the battery cover 20. At this time, the side surface 14 of the button 10 extends outwardly from an end portion of the battery housing member 30, to form a grip portion for facilitating separating the battery cover 20 from the battery housing member 30.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching assembly, comprising:
a battery housing member, the battery housing member having a plurality of latching recesses defined therein;
a battery cover, the battery cover having a plurality of latching portions corresponding to the latching recesses of the battery housing member, the latching portions are releasably latcheable with the latching recesses to releasably mount the battery cover to the battery housing member; and
a button, the button slidably mounted to the battery cover and having a grip portion;
wherein when the button is slid away from the battery cover, the grip portion is exposed from the battery housing member to facilitate releasing the latching portions out of the latching recesses.

2. The battery cover latching assembly as claimed in claim 1, wherein the button comprises a side surface facing the battery housing member to form the grip portion.

3. The battery cover latching assembly as claimed in claim 2, wherein the button has two spaced sliding members extending toward the battery cover, the battery cover has an opening defined therethrough, in which the sliding members are slidably accommodated.

4. The battery cover latching assembly as claimed in claim 3, wherein each sliding member has a slot defined therethrough, the battery cover has two platforms protruding from an inner surface thereof and located at one side of the opening, the platforms respectively correspond to the sliding members, each platform has a projection protruding therefrom and latching with the slot.

5. The battery cover latching assembly as claimed in claim 4, wherein the battery cover has two gaps formed between the platforms and the inner wall thereof, such that the platforms are deflected when the platforms are pressed.

6. The battery cover latching assembly as claimed in claim 5, wherein each sliding member has a stopping portion protruding from a distal end thereof and resisting against the battery cover to stop the sliding members out of the opening.

7. The battery cover latching assembly as claimed in claim 6, wherein the button has a resisting portion protruding therefrom between the sliding members, the battery cover has a securing portion protruding from the inner surface thereof and located another side of the opening, the resisting portion is resisted against the securing portion.

8. A battery cover latching assembly, comprising:
a battery housing member, the battery housing member having a plurality of latching recesses defined therein;
a battery cover, the battery cover having a plurality of latching portions protruding therefrom corresponding to the latching recesses, the latching portions are releasably latcheable with the latching recesses to releasably mount the battery cover to the battery housing member; and
a button, the button slidably mounted to the battery cover and having a grip portion forming thereon;
wherein when detaching the battery cover from the battery housing member, the button is slid away from the battery cover until the grip portion is exposed from the battery housing member, and the grip portion is pushed away from the battery housing member to separate the latching portions from the latching recesses.

9. The battery cover latching assembly as claimed in claim 8, wherein the button comprises a side surface facing the battery housing member to form the grip portion.

10. The battery cover latching assembly as claimed in claim 9, wherein the button has two spaced sliding members extending toward the battery cover, the battery cover has an opening defined therethrough, in which the sliding members are slidably accommodated.

11. The battery cover latching assembly as claimed in claim 10, wherein each sliding member has a slot defined therethrough, the battery cover has two platforms protruding from an inner surface thereof and located at one side of the opening, the platforms respectively correspond to the sliding members, each platform has a projection protruding therefrom and latching with the slot.

12. The battery cover latching assembly as claimed in claim 11, wherein the battery cover has two gaps formed between the platforms and the inner wall thereof, such that the platforms are deflected when the platforms are pressed.

13. The battery cover latching assembly as claimed in claim 12, wherein each sliding member has a stopping portion protruding from a distal end thereof and resisting against the battery cover to stop the sliding members from completely exiting the opening.

14. The battery cover latching assembly as claimed in claim 13, wherein the button has a resisting portion protruding therefrom between the sliding members, the battery cover has a securing portion protruding from the inner surface thereof and located another side of the opening, the resisting portion is resisted against the securing portion.
